(19) United States
(12) Patent Application Publication
(10) Pub. No.: US 2005/0041361 A1
(43) Pub. Date: Feb. 24, 2005

(54) Spray gun with variable load line control

(76) Inventor: Jeffrey A Perkins, Amherst, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/490,756

(22) PCT Filed: Oct. 17, 2002
(86) PCT No.: PCT/US02/33247

Related U.S. Application Data
(60) Provisional application No. 60/330,325, filed on Oct. 18, 2001.
(60) Provisional application No. 60/330,319, filed on Oct. 18, 2001.
(60) Provisional application No. 60/330,321, filed on Oct. 18, 2001.
(60) Provisional application No. 60/330,324, filed on Oct. 18, 2001.

(51) Int. Cl. H02H 1/00

(52) U.S. Cl. 361/225

(57) ABSTRACT

A power supply (80) for an electrostatic spray gun (70) includes a circuit for dynamic manipulation of an operational loadline. Various embodiments are provided, including an analog circuit, a variable frequency circuit, a variable waveform circuit and a variable impedance circuit. The manipulation circuit may be used with either or both of an internal and an external feedback arrangement.

### RELATED APPLICATIONS

This application claims the benefit of the following U.S. provisional patent applications: Ser. No. 60/330,319 filed on Oct. 18, 2001 for CONTROLLING LOAD LINES WITH MULTIPLIER FREQUENCY; Ser. No. 60/330,321, filed on Oct. 18, 2001 for LOAD LINE MANIPULATION USING EQUATION; Ser. No. 60/330,324 filed on Oct. 18, 2001 for ANALOG MULTIPLIER LOAD LINES; and Ser. No. 60/330,325 filed on Oct. 18, 2001 for ALTERNATE METHODS TO CONTROL MULTIPLIER LOAD LINES, the entire disclosures of which are fully incorporated herein by reference.

### FIELD OF THE INVENTION

The invention relates generally to high voltage power supplies used in electrostatic spray devices. More particularly, the invention relates to various apparatus and methods for controlling operational loadlines of the power supply in relation to load conditions.

### BACKGROUND OF THE INVENTION

The present invention builds upon the inventions set forth in U.S. Pat. No. 5,566,042 issued to Perkins et al. (the “'042 patent”) and owned by the assignee of the present invention, the entire disclosure of which is fully incorporated herein by reference. The '042 patent describes a system and methods for dynamically manipulating the operational loadlines of a high voltage power supply in relation to varying load conditions. The '042 patent, in the preferred although not exclusive embodiment, describes a manipulation circuit 16 realized in the form of a microprocessor and an internal memory 29 and an external user interface 25. The user interface 25 could be, for example, a keyboard.

Although a microprocessor based system is very useful in many applications, for some applications such a control system may have more or less functionality than is needed. The present invention therefore is directed to additional embodiments of a manipulation circuit that may be used to carry out the functions and operations described in the '042 patent. The present invention is thus described herein in terms of the '042 disclosure which is repeated herein only to the extent needed to understand and use the present invention. Additional details may be obtained from reading the '042 patent. Although the present invention is described herein in terms of the '042 disclosure, those skilled in the art will readily appreciate that the present invention may be utilized in other power supply designs and spray system applications.

### SUMMARY OF THE PRESENT INVENTION

The present invention is directed to various alternative embodiments for circuits and techniques to manipulate operational loadlines in a power supply used with an electrostatic spray gun for coating spray systems, such as for example, are set forth in the '042 patent. In one embodiment, a manipulation circuit is realized in the form of an analog circuit that combines a feedback signal with an input voltage signal to the power supply. In a specific exemplary embodiment, the feedback signal corresponds to a load condition, such as, for example, the load current. In all embodiments, the feedback signal may be generated in many different forms and/or functions, and may be internally generated meaning that it is based on a sensed condition of the power supply itself, or may be externally generated in the form of an external indication that is input by an operator through an appropriate input device in order to indicate a needed change to the operational loadline.

In another embodiment, the invention contemplates a loadline manipulation circuit that utilizes a digital signal processing (DSP) circuit to produce a waveform that determines an input voltage to the power supply based on a feedback signal. The feedback signal in one embodiment corresponds to a load condition, such as the load current for example.

In still another embodiment, a manipulation circuit is contemplated that varies or otherwise controls a frequency characteristic of the power supply based on a feedback signal. The feedback signal in one embodiment corresponds to a load condition, such as the load current for example.

In still a further embodiment, a manipulation circuit is contemplated that varies or otherwise controls an impedance characteristic of the power supply so as to manipulate an operational loadline. A number of different although non-exclusive embodiments for controlling a impedance characteristic are provided, including but not limited to controlling an input resistance, controlling an output resistance and controlling an impedance characteristic of a step-up transformer used with a voltage multiplication circuit.

These and other aspects and advantages of the invention will be readily appreciated by those skilled in the art from the following detailed description of exemplary embodiments of the invention with reference to the accompanying Figures.

### BRIEF DESCRIPTION OF THE FIGURES

FIG. 1 is a schematic functional block diagram of an electrostatic spray coating system utilizing a dynamic loadline manipulation arrangement of the present invention in the power supply;

FIG. 2 is a functional block diagram of a power supply for an electrostatic spray device such as an electrostatic powder spray gun utilizing a loadline manipulation arrangement in accordance with the invention;

FIG. 3 is a graph of typical characteristic operational loadlines for different multiplier input voltages, for a power supply multiplier circuit such as used in the present invention;

FIG. 4 is a schematic block diagram of an analog manipulation circuit;

FIG. 5 is a schematic block diagram of a variable waveform manipulation circuit;

FIG. 6 is a schematic block diagram of a variable frequency manipulation circuit; and

FIGS. 7-9 are schematic block diagrams of variable impedance manipulation circuits.

### DETAILED DESCRIPTION OF THE INVENTION

INTRODUCTION

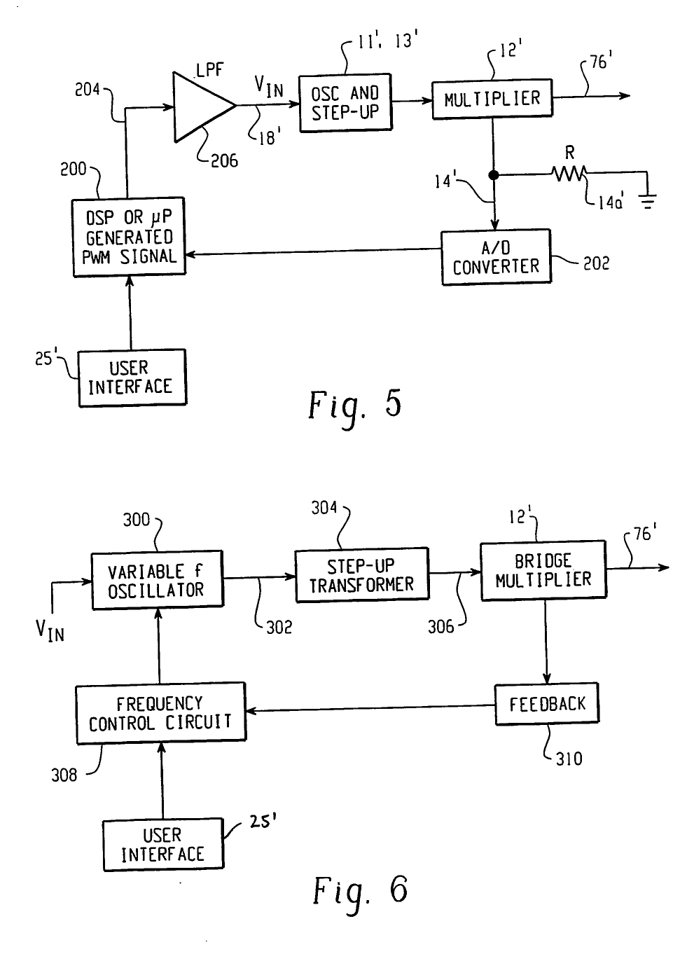

By way of introduction, the present invention is directed to additional embodiments of a loadline manipulation arrangement as described in the '042 patent referenced hereinabove. To the extent that it is useful to repeat some of the disclosure of the '042 patent herein, like reference numerals will be used followed by a prime (′). For example, the coating material supply 84 illustrated in FIG. 5 of the '042 patent is identified as coating material supply 84′ herein. A detailed understanding of such elements may be obtained from the '042 patent and need not be repeated herein. The present invention contemplates various embodiments for carrying out the functional aspects of the loadline manipulation circuit 16 of the '042 patent, that is to say, manipulating the operational loadline in response to load conditions. Again, specific details of an exemplary loadline manipulation scheme may be obtained from reading the '042 patent and need not be repeated herein.

With reference then to FIG. 1 hereof (which corresponds to FIG. 5 of the '042 patent), a typical but not exclusive electrostatic spray coating system S that may be utilized with the present invention includes an electrostatic spray device such as a spray gun 70′ that is used to spray an object 72′ with coating material 74′. Typically the object is grounded as at 92′ although this is not always required in all applications. Electrostatic charging of the coating material is achieved via a high voltage electrode 76′ which may be powered by either an internal power supply 78′ (shown in phantom) or an external power supply 80′. Note that whether the power supply is internal or external with respect to the spray gun 70′ is a different point of reference than when it is stated herein that a feedback signal is internally or externally generated with respect to the power supply, as will be more apparent from the descriptions hereinafter. The coating system S further includes a coating material supply 84′ which is connected to the spray gun 70′ by an appropriate supply hose 86′. The coating material may be either powder or liquid or any other form as appropriate. Electrostatic spray devices also may utilize an appropriate air supply 88′ connected to the spray device by a suitable air hose 90′.

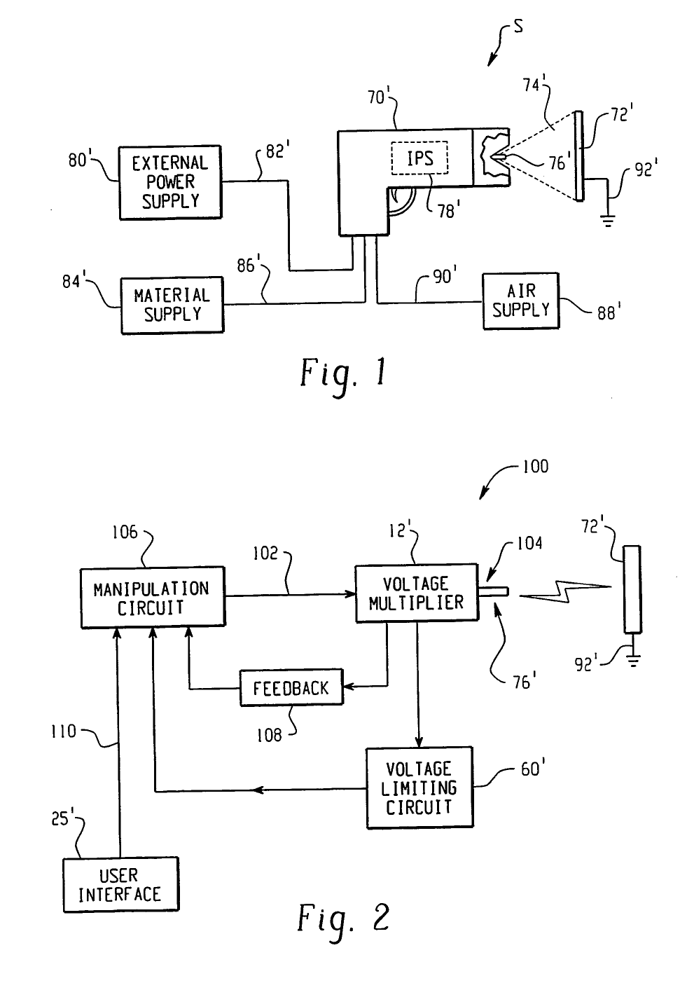

With reference to FIG. 2, a schematic diagram of a power supply 100 having a dynamic loadline manipulation arrangement in accordance with the invention is illustrated in functional block diagram form. The power supply 100 shares many common features with the disclosure of the '042 patent, and in fact FIG. 2 hereof is a generalized schematic of the circuit illustrated in FIG. 1 of the '042 patent. The reason for the more generalized schematic herein is because the present invention is directed to additional embodiments of the manipulation circuit 16′ of the '042 patent and therefore does not necessarily interface to the voltage multiplier circuit 12′ in exactly the same way as in the '042 patent.

The power supply 100 includes a high voltage multiplier bridge 12′ which converts an input signal 102 into a high DC output voltage 104, for example, in the range of about 60 to about 100 kilovolts (KV) but this exemplary output range is not a limitation of the present invention. The power supply output 104 is applied to the electrode 76′ which charges the coating material 74′ (FIG. 1) applied to the object 72′. A manipulation circuit 106 is used to produce the input signal 102. The manipulation circuit 106 may include an input voltage circuit such as the circuit 10′ in the '042 patent as will be described hereinafter. The power supply 100 may further include a user interface 25′ and a voltage limiting circuit 60′ as described in the '042 patent. The user interface 25′ may be used to input an external feedback 110 to the manipulation circuit 106.

For example, in some embodiments the user may indicate a change in spraying parameters in response to knowing that the user has changed powder or will be positioning the gun closer to the object to name just two of many examples. Some of the embodiments herein utilize an internal feedback arrangement 108, with or without the use of an external feedback input from the user interface 25′. In any case, a feedback indication whether internally or externally generated may be used to indicate to the manipulation circuit 106 that there has been a change in a load condition. As in the '042 patent, the manipulation circuit 106 then makes the appropriate adjustment to the operational loadline as set forth hereinafter.

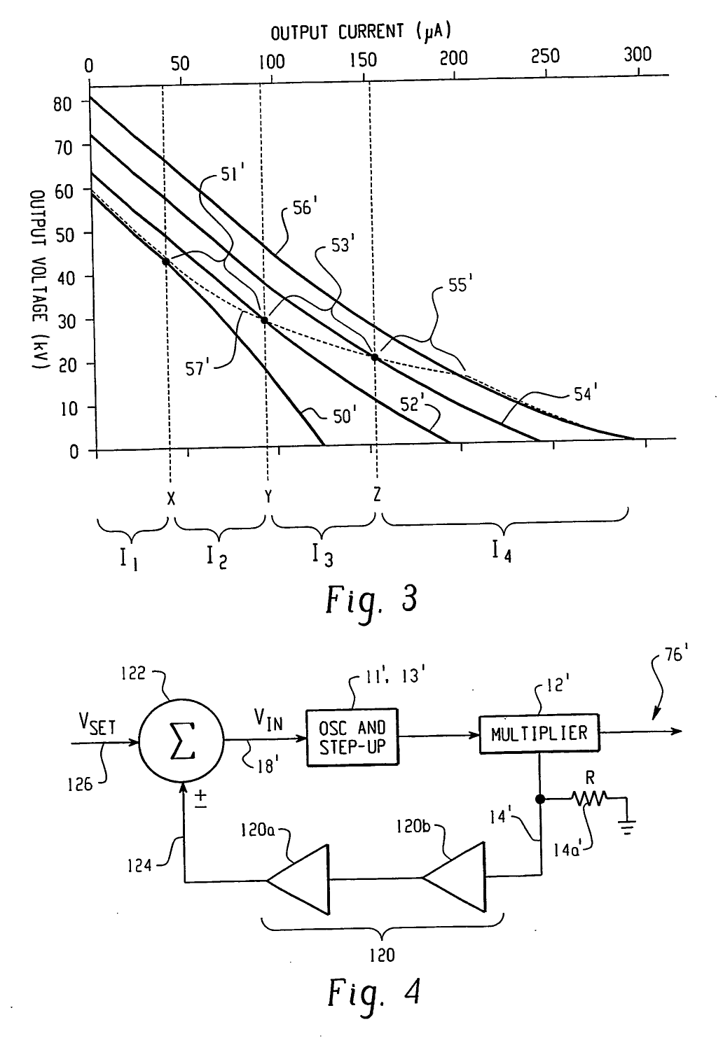

The power supply output 104 is characterized by an output voltage and a load current that are related by characteristic loadlines as illustrated in an exemplary manner in FIG. 3 hereof (corresponding to FIG. 2 of the '042 patent). Each characteristic loadline is determined by the design of the multiplier circuit and the input voltage to the multiplier circuit. The manipulation circuit 106 produces an operational loadline such as, for example, the loadline 57′ by using feedback or another appropriate input signal to adjust or control either the input voltage to the multiplier or to adjust or control an impedance characteristic of the circuit, or alternatively both functions may be combined as required. However, the particular shape of the loadline 57′ may be selected by the designer based on the various operational parameters of the spraying system. The various embodiments herein exemplify additional options available to a designer to implement an appropriate manipulation circuit for carrying out the dynamic loadline manipulation contemplated in the '042 patent as well as other loadline manipulation techniques that will be available to the designer based on this disclosure. In general, the manipulation circuit 106 operates to control either the input voltage to the multiplier, as was the exemplary case in the '042 patent, or an impedance characteristic of the circuit so as to effect the operational loadline manipulation.

The loadline manipulation carried out by the manipulation circuit 106 may be as set forth in the '042 patent, or may implement different loadline manipulation schemes. Thus, the present invention is not necessarily limited to the specific loadline manipulation scheme of the '042 patent although that approach is certainly appropriate in many applications.

In the '042 patent, the multiplier bridge 12′ increases the voltage level of a drive signal that is received from an oscillator 11′ through a step-up transformer 13′. The oscillator 11′ and the transformer 13′ may be physically integrated into the multiplier 12′, or may be a separate arrangement of the power supply. In either case, the voltage V_{IN} in the '042 patent in general is an input signal and the voltage multiplier 12′ produces an output related thereto, recognizing that, at least in the exemplary embodiment, there are additional circuit components such as the oscillator and transformer. Those skilled in the art will appreciate however that the particular configuration of an oscillator/transformer/multiplier bridge circuit is but one way to implement the present invention. In most of the embodiments herein the input signal corresponds to the DC input voltage to the oscillator 11′, but in some of the embodiments herein, the manipulation circuit 106 changes one or more characteristics of the drive signal into the transformer 13′ (such as the variable frequency embodiment) or produced out of the transformer (such as the variable impedance embodiment that adjusts the secondary winding impedance or load impedance).

ANALOG MANIPULATION CIRCUIT

With reference to FIG. 4, in one embodiment of the invention the manipulation circuit 106 is realized in the form of an entirely analog circuit for adjusting the input voltage V_{IN} to the oscillator 11′, step-up transformer 13′ and the voltage multiplier 12′ based on an appropriately selected feedback. In this exemplary embodiment, the manipulation circuit 106 achieves a similar result as the embodiment of FIG. 1 of the '042 patent, except that the microprocessor based manipulation circuit 16 has been replaced with an all analog arrangement. Accordingly, feedback is generated in a similar manner by the use of a feedback resistor 14a′ that senses a load condition such as, for example, the load current of the multiplier 12′, and generates a feedback voltage signal 14′. It is important to note that for all the embodiments herein any suitable feedback format may be used, and furthermore the feedback need not be exclusively or even partially based on the load current. Rather, the feedback is used to provide an appropriate signal or other indication selected by the designer that corresponds with a load condition so as to adjust the operational loadline accordingly. The multiplier 12′ operates from an input voltage 18′ (V_{IN}) in the same manner for operational loadline adjustment as the description in the '042 patent and as set forth hereinabove. The feedback voltage 14′ is input to one or more (two, 120a and 120b, are shown in FIG. 4) analog gain stages 120. The number of stages 120 will depend on the gain required, if any (unity gain amplifiers may also be used as appropriate), as well as to effect the correct polarity into a summation circuit 122.

The gain stages 120 as well as the summation circuit 122 may be realized in any suitable analog fashion well known to those skilled in the art, including but not limited to inverting and non-inverting gain operational amplifiers. The gain stage 120 produces an adjustment signal 124 that is input to the summation circuit 122 and combined (added or subtracted for example) as appropriate with a reference voltage 126 (V_{SET}) to produce the input voltage V_{IN} to oscillator 11′, transformer 13′ and the multiplier 12′. The selectable value of the reference voltage 126 will depend on the selected design of the power supply. Note that V_{SET} determines the Y-intercept (no-load condition) in FIG. 3 hereof. As an example, the reference voltage 126 may be the maximum value for V_{IN} that is to be applied to the multiplier 12′ so that the feedback is used to adjust the slope of the loadline by simply lowering V_{IN} in response to load conditions. Another example would be to set the reference voltage at a midrange of V_{IN} so that the feedback may be used to adjust the slope of the loadline up and down as required in response to load conditions. In any case, the embodiment of FIG. 4 achieves the operation of the '042 scheme with an entirely analog manipulation circuit. Note that in the embodiment of FIG. 4 the user interface 25′ is not provided for because there is no requirement for the operator to adjust circuit parameters. However, a user interface 25′ may optionally be provided as required for a particular power supply design. The reference voltage V_{SET}, for example, may be input from the user interface or other externally controlled source for additional design flexibility. Additionally, the gain of the gain stage 120 may be electronically controlled based on an external input. As another example, the reference voltage V_{SET} may be automatically determined by an appropriate controller that adjusts the value of V_{SET} based on various spraying parameters, or can be manually adjusted by the operator through a variable resistance to name another example of many. Note that in the broader sense, an input from the operator such as through a user interface 25′ or other manual input technique (such as adjusting a resistance and so on) may be considered to be an analog feedback. The user based feedback may be used in combination with the internal feedback (such as the sense resistor 14a′) or without the use of internal feedback.

VARIABLE WAVEFORM MANIPULATION CIRCUIT

With reference to FIG. 5, the manipulation circuit in this embodiment is a digital electronic control circuit 200 that is used to control V_{IN} to the multiplier 12′ through the oscillator 11′ and the transformer 13′. Again, the feedback 14′ may be realized using a load current sensing resistor 14a′ or any other suitable feedback arrangement. An analog to digital (A/D) converter 202 is used to digitize the feedback signal 14′ for input to the control circuit 200. It is contemplated in this embodiment that the control circuit 200 is programmable to implement through software a pulse width modulated (PWM) or other suitably adjustable variable control signal 204 (frequency, amplitude or pulse width modulation). For example, the control circuit 200 may be realized using a conventional digital signal processing (DSP) circuit designed in accordance with conventional DSP practice well known to those skilled in the art. Alternatively, the control circuit 200 may be realized using a microprocessor or other suitable programmable device. DSP is particularly useful for generating variable signals such as PWM signals based on one or more input signals. In this case, the DSP circuit 200 generates a PWM signal 204 based on the operating range of V_{IN} and the feedback signal 14′. The PWM signal 204 is input to a conventional low pass filter (LPF) 206 or functionally comparable circuit to produce the DC input voltage 18′ to the multiplier 12′ so as to effect the loadline manipulation. Again, the loadline manipulation may be as implemented in the '042 patent as set forth above as one example. An advantage of using DSP is that the circuit software may be used to produce virtually any operational loadline response to the load condition as may be desired by the designer.

The DSP circuit 200, for example, may be used to implement the equation V_{IN}=K₁+K₂*(Iₒ) where K₁ is the no load condition, Iₒ is the output load current and K₂ is an equation, function, algorithm or other set of rules implemented through software in a conventional manner in DSP to realize a desired shape or response curve for the loadline (for example, the loadline shape 57′ in FIG. 3). Iₒ of course is available through the corresponding feedback selected, and K₂ may be, for example, determined by various internal impedances in the multiplier circuit 12′ and how those impedances affect the loadline under differing load conditions. Thus K₂ itself may be a function of Iₒ, or it may simply be a linear adjustment of the PWM signal based on the feedback signal that corresponds to the load condition. Thus the use of DSP or other programmable control circuit greatly expands the flexibility of the power supply loadline manipulation available to the designer.

Note that an additional option is that the user interface 25′ may be used to provide an operator the opportunity to instruct the control circuit 200 on how to adjust the input voltage. For example, the operator may input a command (external feedback) that tells the control circuit 200 that a new load condition will be presented (e.g. the operator may have changed powder or the object or may be positioning the spray gun closer to the object). This optional external feedback input may be used in lieu of or in addition to the use of the internal feedback 14′.

VARIABLE FREQUENCY MANIPULATION CIRCUIT

With reference to FIG. 6, in still a further embodiment, the manipulation circuit is implemented based on the fact that the power supply output voltage is a function of frequency as well as the input voltage and load current. The multiplier 12′ in the exemplary embodiment is a Cockroft Walton bridge as is well known in the art. Such a multiplier uses a series of diode-capacitor rectifier stages to convert an AC voltage signal into a rectified high voltage DC signal. The number of stages determines the output voltage level based on the input voltage. The AC input to the multiplier stages is typically accomplished by an oscillator and step-up transformer, such as the fixed oscillator 11′ and transformer 13′ of the '042 patent. The DC input voltage V_{IN} is used to drive the oscillator 11′ which produces a fixed frequency excitation signal of about 20-100 volts at about 23 KHz to the step-up transformer 13′, however these values are exemplary in nature and should not be construed as being a limitation on the present invention. The voltage multiplier 12′ then converts the AC drive signal to the high voltage rectified output of the power supply.

It is known that the multiplier 12′ can be characterized by the following equation:
V_{OUT}=N*(V₁−V₂)/2−[N^{a}/12Cf]*Iₒ Eq. 1

where N is the number of stages, V₁−V₂ is the peak to peak voltage of the drive signal, C is the capacitance of the multiplier capacitors and f is the drive signal frequency. Thus, by adjusting the value of f, the relationship between the output voltage and output current Iₒ, hence the loadline, can be manipulated.

FIG. 6 illustrates an exemplary embodiment of a circuit for effecting frequency control for loadline manipulation. The input voltage V_{IN} may still be used as the basic drive voltage that determines the no-load operational loadline. Alternatively the frequency control aspect of this embodiment may be used in combination with a control function for the input voltage V_{IN}.

The fixed oscillator of the '042 patent is now replaced with a variable frequency oscillator 300. This oscillator may be realized in any number of well known circuit designs such as, for example and not by way of limitation, a voltage controlled oscillator (VCO), digital timers and so on, or alternatively could be incorporated into a DSP type signal generator circuit. The oscillator 300 provides an AC drive signal 302 to the step-up transformer 304 based on the selected frequency and the value of V_{IN}. The step-up transformer produces the AC drive signal 306 to the multiplier 12′.

Control of the oscillator 300 frequency may be implemented using a suitable control circuit 308. The frequency control circuit 308 may be any convenient design such as an integrated circuit such as a microprocessor or DSP, or also as an analog or discrete digital circuit. The control circuit 308 adjusts the frequency of the oscillator 300 based on either or both of an external feedback from the user interface 25′ or an internal feedback 310, such as, for example, a feedback signal that corresponds to the load condition such as load current as implemented in the prior embodiments herein. For example, in a manner similar to the manipulation scheme of the '042 patent and FIG. 3 hereof, the control circuit 308 may adjust the frequency of the oscillator so as to adjust the output voltage of the multiplier 12′ up or down based on the load current. The adjustment of the frequency is somewhat analogous to adjusting the input voltage V_{IN} as done in the '042 patent in that adjusting the frequency affects the drive signal to the multiplier 12′ just as does adjusting the voltage V_{IN}. Depending on the multiplier circuit used, adjustments in frequency as small as 1 Hz may be used to affect dynamic loadline manipulation.

It is important to note that the present invention is not limited to the use of a Cockroft-Walton bridge type multiplier circuit. Any multiplier circuit design may be used by which the loadline characteristics can be adjusted based on a variable frequency.

VARIABLE IMPEDANCE MANIPULATION CIRCUIT

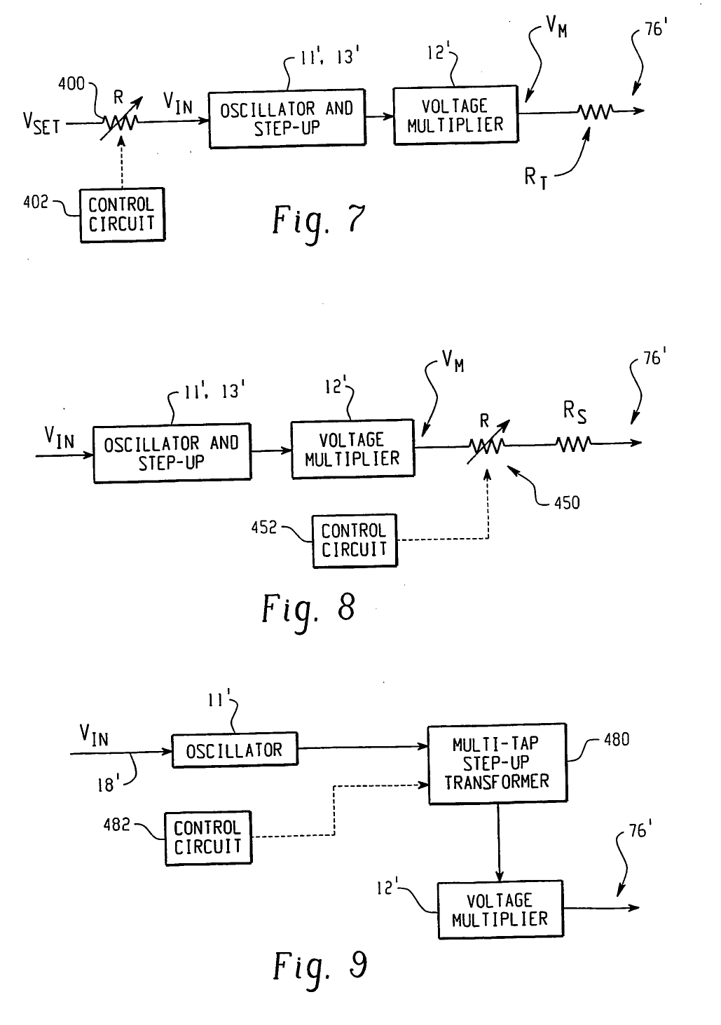

Still another technique to implement dynamic loadline manipulation is illustrated in FIGS. 7, 8 and 9. These embodiments are all based on the concept of controlling an impedance characteristic of the power supply so as to implement manipulation of the operational loadline. The different impedance controls may be used alone or in any combination with the others, as well as in any suitable combination with the other embodiments described herein.

In the embodiment of FIG. 7, a variable resistance 400 is used. The resistance 400 may be manually changed such as by an operator using a potentiometer or other switchable resistance, or electronically such as with a variable resistance that is varied by a suitable optional control circuit 402 (in phantom in FIG. 7).

The embodiment of FIG. 7 takes advantage of the fact that the input voltage V_{IN} is a function of the output voltage when the resistance R is inserted into the circuit. This is because the input current is proportional to the output load current due to the presence of the step-up transformer 13′. In general, the following equation applies:
V_{OUT}=V_{IN}*G−IₒR_{T}

where G is the gain factor of the multiplier 12′ (i.e. the multiplier 12′ produces a voltage Vm that is equal to the input voltage V_{IN} times a gain factor G) and R_{T} is the total resistance in series between the multiplier output voltage Vₘ and the electrode 76′. V_{IN} however is a function of Iₒ according to the simplified equation V_{IN}=V_{SET}−IₒHR where H is a factor that relates the output load current to the input current according to the equation I_{IN}=I_{OUT}*H due to the step-up transformer 13′. Therefore, the following equation can be derived:
V_{OUT}=V_{SET}*G−(G*H*R+R_{T})*Iₒ

Note that the relationship between V_{OUT} and Iₒ (i.e. the loadline characteristic) is a function of the resistance R, so that by changing R the loadline can be manipulated. The value V_{SET} again determines the no-load Y-intercept of the loadline. The resistance R in FIG. 7 may be changed electronically by the control circuit 402 based on an internal feedback signal as described hereinbefore (such as for example using a feedback resistor to sense the load current) or an external feedback such as using the user interface 25′ (not shown) to instruct the control circuit 402 to change the resistance R appropriately. The actual implementation of the control circuit 402 may be in any suitable configuration well known to those skilled in the art to perform the function of controlling the resistance R

The embodiment of FIG. 8 is similar in some respects to FIG. 7 except that the variable resistance R (450) is now disposed on the output side of the power supply between the multiplier output voltage Vₘ and the electrode 76′. Again, the resistance R may be varied by an operator manually adjusting the resistance 450 or electronically through a optional control circuit 452 that responds to a suitable feedback as in the case of the FIG. 7 embodiment. The variable resistance R may be in lieu of or in addition to a typical series resistor R_{S} used in many electrostatic spray guns to prevent arcing. The following equation can be derived for the circuit of FIG. 8:
V_{OUT}=V_{IN}*G−Iₒ(R+R_{S})

where G is as defined hereinabove.

This embodiment may require the use of high power switching devices as it is on the output side of the power supply. Note that by appropriate changes to R, the operational loadline relationship between V_{OUT} and I^{O} can be manipulated as described hereinbefore.

Note that in both the embodiments of FIGS. 7 and 8 varying the value of R affects the slope of the loadline but does not change the no-load Y-intercept for V_{OUT}; however this may be implemented with an additional control for V_{SET} if so required for a particular application.

FIG. 9 illustrates an embodiment for varying yet another impedance characteristic of the power supply. In this embodiment, the step-up transformer 480 is realized in the form of a multi-tap secondary that can be switched either manually or electronically by a suitable control circuit 482. The multi-tap secondary allows for changing the effective number of turns of the secondary of the transformer 480 by any suitable technique well known to those skilled in the art, thereby changing the value V_{OUT} as required according to the equation: V_{OUT}=V_{IN}*N_{T}*F−IₒR_{T} wherein N_{T} is the number of secondary turns, F is the multiplier gain and R_{T} is as defined hereinbefore. The control circuit 482 may adjust the number of turns based on an internal or external feedback as described hereinabove. Note that the embodiment of FIG. 9 will effect a change in the no-load Y-intercept of V_{OUT}.

It is intended that invention not be limited to the particular embodiments and alternative embodiments disclosed as the best mode or preferred mode contemplated for carrying out the invention, but that the invention will include all embodiments falling within the scope of the appended claims.

1. A power supply for use in an electrostatic spray device, comprising:
an input voltage circuit that produces an input voltage;
a voltage multiplication circuit that produces a power supply output in response to said input voltage; said power supply output including an output voltage and a load current; said output voltage and load current being related by a selectable operational loadline; and
a manipulation circuit coupled to said voltage multiplication circuit that adjusts said operational loadline;
said manipulation circuit comprising a feedback circuit that produces an analog feedback signal related to said load current, and an analog control circuit that receives said analog feedback signal and adjusts said operational loadline in relation to said analog feedback signal.

2. The supply of claim 1 wherein said analog feedback signal comprises feedback voltage that corresponds to load current; said analog control circuit combining said analog feedback voltage with an analog set voltage to produce said input voltage.

3. The supply of claim 2 wherein said set voltage corresponds to a no load operational loadline for the power supply.

4. A power supply for use in an electrostatic spray device, comprising:
a voltage multiplication circuit that produces a power supply output in response to an input voltage; said power supply output comprising an output voltage and a load current which are related by a selectable operational loadline; and
a manipulation circuit coupled to said voltage multiplication circuit that adjusts said operational loadline by controlling said input voltage;
said manipulation circuit comprising a feedback circuit that produces a feedback signal that corresponds to said load current, and a programmable control circuit that produces a control waveform based on said feedback signal and a set of software instructions; wherein said control waveform determines said input voltage.

5. The power supply of claim 4 wherein said programmable control circuit comprises a DSP circuit.

6. The power supply of claim 5 wherein said DSP circuit produces a PWM waveform in relation to said feedback signal.

7. The power supply of claim 6 wherein said PWM waveform is input to a low pass filter that produces said input voltage to said voltage multiplication circuit.

8. A power supply for use in an electrostatic spray device, comprising:
an input voltage circuit that produces an input voltage;
a voltage multiplication circuit that produces a power supply output in response to said input voltage; said power supply output comprising an output voltage and a load current which are related by a selectable operational loadline; and
a manipulation circuit that adjusts said operational loadline; said manipulation circuit comprising a variable frequency oscillator that produces a drive signal to said voltage multiplication circuit in response to said input voltage.

9. The power supply of claim 8 wherein said manipulation circuit receives a feedback signal that corresponds to a load condition, said manipulation circuit adjusting said operational loadline by adjusting said drive signal frequency based on said feedback signal.

10. The power supply of claim 9 wherein said feedback signal corresponds to said load current.

11. The power supply of claim 9 wherein said feedback signal is based on an external input signal.

12. The power supply of claim 9 wherein said manipulation circuit comprises a programmable DSP circuit.

13. A power supply for use in an electrostatic spray device, comprising:
an input voltage circuit that produces an input voltage;
a voltage multiplication circuit that produces a power supply output in response to said input voltage; said power supply output comprising an output voltage and a load current which are related by a selectable load line; and
a manipulation circuit that adjusts said operational loadline based on a load condition by controlling an impedance characteristic of one or both of said input voltage circuit and said multiplication circuit.

14. The power supply of claim 13 wherein said manipulation circuit comprises a variable resistance coupled between said input voltage and said voltage multiplication circuit.

15. The power supply of claim 14 wherein said variable resistance is adjusted by an external manual control.

16. The power supply of claim 14 wherein variable resistance is electronically controlled by said manipulation circuit based on a feedback signal that corresponds to a load condition.

17. The power supply of claim 13 wherein said manipulation circuit comprises a variable resistance coupled to said voltage multiplication circuit.

18. The power supply of claim 17 wherein said variable resistance forms part of an output impedance of said voltage multiplication circuit.

19. The power supply of claim 13 wherein said manipulation circuit controls an impedance characteristic of a step up transformer that produces an input drive signal to said voltage multiplication circuit.

20. The power supply of claim 1 in combination with a powder coating spray system comprising a powder spray gun and a system for supply powder coating material to said spray gun.

21. The power supply of claim 4 in combination with a powder coating spray system comprising a powder spray gun and a system for supply powder coating material to said spray gun.

22. The power supply of claim 8 in combination with a powder coating spray system comprising a powder spray gun and a system for supply powder coating material to said spray gun.

23. The power supply of claim 13 in combination with a powder coating spray system comprising a powder spray gun and a system for supply powder coating material to said spray gun.

24. A coating system by applying a coating material to an object comprising:
an electrostatic spray device with an electrode for spraying coating material onto an object;
a system for supplying coating material to the spray device so that it may be sprayed therefrom;
a power supply connected to the electrode to charge the electrode so that it electrostatically charges the coating material as it is sprayed from the spray device, the power supply comprising:
an input voltage circuit that produces an input voltage;
a voltage multiplication circuit that produces a power supply output in response to said input voltage; said power supply output including an output voltage and a load current; said output voltage and load current being related by a selectable operational loadline; and
a manipulation circuit coupled to said voltage multiplication circuit that adjusts said operational loadline;
said manipulation circuit comprising a feedback circuit that produces an analog feedback signal related to said load current, and an analog control circuit that receives said analog feedback signal and adjusts said operational loadline in relation to said analog feedback signal.

25. A coating system by applying a coating material to an object comprising:
an electrostatic spray device with an electrode for spraying coating material onto an object:
a system for supplying coating material to the spray device so that it may be sprayed therefrom;
a power supply connected to the electrode to charge the electrode so that it electrostatically charges the coating material as it is sprayed from the spray device, the power supply comprising:
a voltage multiplication circuit that produces a power supply output in response to an input voltage; said power supply output comprising an output voltage and a load current which are related by a selectable operational loadline; and
a manipulation circuit coupled to said voltage multiplication circuit that adjusts said operational loadline by controlling said input voltage;
said manipulation circuit comprising a feedback circuit that produces a feedback signal that corresponds to said load current, and a programmable control circuit that produces a control waveform based on said feedback signal and a set of software instructions; wherein said control waveform determines said input voltage.

26. A coating system by applying a coating material to an object comprising:
an electrostatic spray device with an electrode for spraying coating material onto an object;
a system for supplying coating material to the spray device so that it may be sprayed therefrom;
a power supply connected to the electrode to charge the electrode so that it electrostatically charges the coating material as it is sprayed from the spray device, the power supply comprising:
an input voltage circuit that produces an input voltage;
a voltage multiplication circuit that produces a power supply output in response to said input voltage; said power supply output comprising an output voltage and a load current which are related by a selectable operational loadline; and
a manipulation circuit that adjusts said operational loadline; said manipulation circuit comprising a variable frequency oscillator that produces a drive signal to said voltage multiplication circuit in response to said input voltage.

27. A coating system by applying a coating material to an object comprising:
an electrostatic spray device with an electrode for spraying coating material onto an object;
a system for supplying coating material to the spray device so that it may be sprayed therefrom;
a power supply connected to the electrode to charge the electrode so that it electrostatically charges the coating material as it is sprayed from the spray device, the power supply comprising:
an input voltage circuit that produces an input voltage;
a voltage multiplication circuit that produces a power supply output in response to said input voltage; said power supply output comprising an output voltage and a load current which are related by a selectable load line; and
a manipulation circuit that adjusts said operational loadline based on a load condition by controlling an impedance characteristic of one or both of said input voltage circuit and said multiplication circuit.
